(19) United States
(12) Patent Application Publication
(10) Pub. No.: US 2008/0174130 A1
(43) Pub. Date: Jul. 24, 2008

(54) Safety hook

(75) Inventor: Yu-Wen Lin, Taipei (TW)

Correspondence Address: DLA PIPER US LLP, 2000 UNIVERSITY AVENUE, E. PALO ALTO, CA, 94303-2248, US

(73) Assignee: Usang Industrial Co., Ltd.

(21) Appl. No.: 11/973,915

(22) Filed: Oct. 10, 2007

(30) Foreign Application Priority Data
Jan. 18, 2007 (TW) 096200988

(51) Int. Cl. B66C 1/36

(52) U.S. Cl. 294/82.2

(57) ABSTRACT

A safety hook includes: a hook body having a base segment, a hook segment, and an arm segment extending between the base segment and the hook segment; a latch unit pivoted to the base segment so as to be rotatable between closed and opened positions, the latch unit being formed with a guiding groove that has an end section defined by an abutting wall; and a latch-locking unit pivoted to the arm segment as to be rotatable between locked and unlocked positions. The latch-locking unit includes an operating lever pivoted to the arm segment, and a limiting rod extending through the guiding groove, co-rotatable with the operating lever, and abutting slidingly against the arm segment, and received in the end section of the guiding groove when the latch-locking unit is disposed at the locked position.

### CROSS-REFERENCE TO RELATED APPLICATION

This application claims priority of Taiwanese Application No. 096200988, filed on Jan. 18, 2007.

### BACKGROUND OF THE INVENTION

1. Field of the Invention

The invention relates to a safety hook, more particularly to a safety hook including a hook body, a latch unit and a limiting rod extending through the latch unit and in sliding contact with the hook body.

2. Description of the Related Art

FIG. 1 illustrates a conventional safety hook that includes a hook body 4, a latch unit 5, and a latch-locking unit 6. The hook body 4 includes a base segment 43, a hook segment 40 cooperating with the base segment 43 to define a hook mouth 410 of the hook body 4, and an arm segment 42 extending between the base segment 43 and the hook segment 40. The latch unit 5 is pivoted to the base segment 43 so as to be rotatable relative to the hook body 4 in a rotational direction between closed and opened positions for covering and uncovering the hook mouth 410, respectively. The latch unit 5 is formed with a guiding groove 51 which has an arcuate section 511 and an end section 510 that turns from the arcuate section 511 and that is defined by an abutting wall. The latch-locking unit 6 is pivoted to the arm segment 42 so as to be rotatable relative to the hook body 4 between locked and unlocked positions for locking and unlocking the latch unit 5 when the latch unit 5 is disposed at the closed position. The latch-locking unit 6 includes an operating lever 60 pivoted to the arm segment 42, and a limiting rod 61 extending through the operating lever 60 and the guiding groove 51, and co-rotatable with the operating lever 60. The limiting rod 61 is received in the end section 510 of the guiding groove 51 and abuts against the abutting wall of the end section 510 so as to prevent the latch unit 5 from rotating in the rotational direction when the latch unit 5 is disposed at the closed position.

However, since the limiting rod 61 is only limited by the abutting wall of the end section 510 of the guiding groove 51 when the hook body 4 is disposed at the closed position, the latch unit 5 is likely to be moved undesirably from the closed position to the opened position.

### SUMMARY OF THE INVENTION

Therefore, the object of the present invention is to provide a safety hook that can overcome the aforesaid drawback associated with the prior art.

Accordingly, a safety hook of this invention comprises: a hook body having a base segment, a hook segment cooperating with the base segment to define a hook mouth of the hook body, and an arm segment extending between the base segment and the hook segment; a latch unit pivoted to the base segment so as to be rotatable relative to the hook body in a rotational direction between closed and opened positions for covering and uncovering the hook mouth, respectively, the latch unit being formed with a guiding groove which has an arcuate section and an end section that turns from the arcuate section and that is defined by an abutting wall; and a latch-locking unit connected to the latch unit and pivoted to the arm segment so as to be rotatable relative to the hook body between locked and unlocked positions for locking and unlocking the latch unit when the latch unit is disposed at the closed position. The latch-locking unit includes an operating lever pivoted to the arm segment, and a limiting rod extending through the operating lever and the guiding groove, co-rotatable with the operating lever, and abutting slidingly against the arm segment. The limiting rod is received in the end section of the guiding groove when the latch-locking unit is disposed at the locked position so as to permit abutment between the limiting rod and the abutting wall, thereby blocking the latch unit from rotating in the rotational direction.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional safety hook in a locked state;

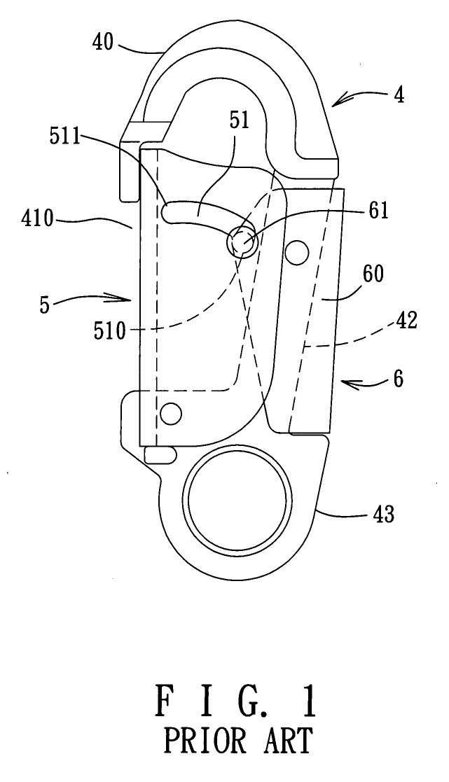

FIG. 2 is a schematic view of the first preferred embodiment of a safety hook according to the present invention in a locked and closed state;

FIG. 3 is a schematic view of the first preferred embodiment in an unlocked and opened state;

FIG. 4 is schematic view of the second preferred embodiment of the safety hook according to the present invention in a locked and closed state; and

FIG. 5 is a schematic view of the second preferred embodiment in an unlocked and opened state.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

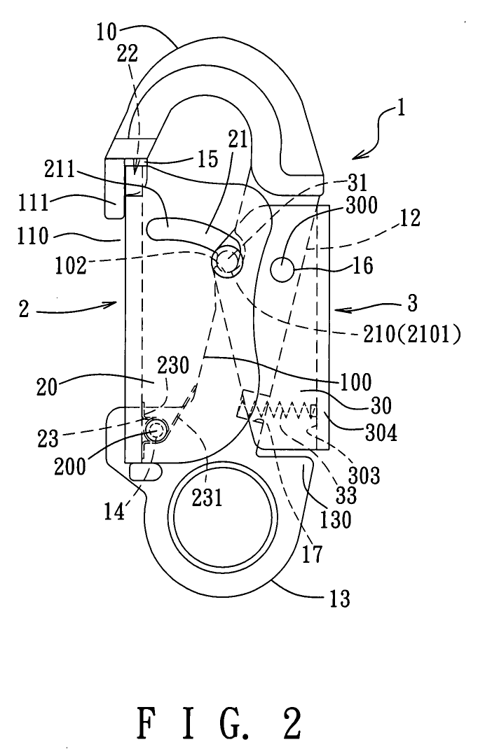

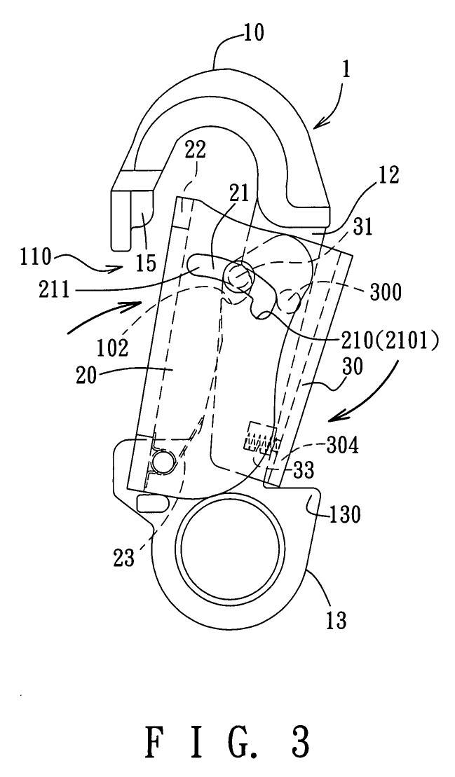

Referring to FIGS. 2 and 3, the first preferred embodiment of a safety hook according to the present invention is shown to include: a hook body 1 having a base segment 13, a hook segment 10 cooperating with the base segment 13 to define a hook mouth 110 of the hook body 1, and an arm segment 12 extending between the base segment 13 and the hook segment 10; a latch unit 2 pivoted to the base segment 13 so as to be rotatable relative to the hook body 1 in a rotational direction between closed and opened positions (see FIGS. 2 and 3) for covering and uncovering the hook mouth 110, respectively, the latch unit 2 being formed with a guiding groove 21 which has an arcuate section 211 and an end section 210 that turns from the arcuate section 211 and that is defined by an abutting wall 2101; and a latch-locking unit 3 connected to the latch unit 2 and pivoted to the arm segment 12 so as to be rotatable relative to the hook body 1 between locked and unlocked positions (see FIGS. 2 and 3) for locking and unlocking the latch unit 2 when the latch unit 2 is disposed at the closed position. The latch-locking unit 3 includes an operating lever 30 pivoted to the arm segment 12, and a limiting rod 31 extending through the operating lever 30 and the guiding groove 21, co-rotatable with the operating lever 30, and abutting slidingly against the arm segment 12. The limiting rod 31 is received in the end section 210 of the guiding groove 21 when the latch-locking unit 3 is disposed at the locked position so as to permit abutment between the limiting rod 31 and the abutting wall 2101, thereby blocking the latch unit 2 from rotating in the rotational direction.

In this embodiment, the arm segment 12 of the hook body 1 has an inner side 100 formed with a retaining recess 102. The limiting rod 31 is received in the retaining recess 102 when the latch-locking unit 3 is disposed at the locked position, thereby enhancing the locking effect on the latch unit 2.

The hook segment 10 has a free end 111 formed with a protrusion 15. The latch unit 2 includes a generally U-shaped plate 20 having a free end that is formed with a confining hole 22 for extension of the protrusion 15 of the free end 111 of the hook segment 10 thereinto when the latch unit 2 is disposed at the closed position. The base segment 13 of the hook body 1 is formed with a first pivot hole 14. The latch unit 2 has a first pivot axle 200 extending through the U-shaped plate 20 and the first pivot hole 14 in the base segment 13. The safety hook further includes a torsion spring 23 sleeved on the first pivot axle 200 and having one end 230 abutting against the U-shaped plate 20 and the other end 231 abutting against the inner side 100 of the arm segment 13 for urging the U-shaped plate 20 of the latch unit 2 to abut against the free end 111 of the hook segment 10 of the hook body 1.

The arm segment 12 of the hook body 1 is formed with a second pivot hole 16. The latch-locking unit 3 has a second pivot axle 300 extending through the operating lever 30 and the second pivot hole 16. The arm segment 12 has an outer side formed with a spring retaining hole 17. The operating lever 30 is in the form of a generally U-shaped plate, and has an inner side 303 formed with a spring-retaining stud registered with the spring retaining hole 17. The safety hook further includes a compressing spring 33 having one end sleeved on the stud and the other end retained in the spring retaining hole 17 for urging the operating lever 30 to abut against the arm segment 12 and the limiting rod 31 to abut against the inner side 100 of the arm segment 12.

The operating lever 30 of the latch locking unit 3 has an end portion 304 extending rearwardly beyond a rear end 130 of the base segment 13 for preventing undesired movement of the latch-locking unit 3 from the locked position to the unlocked position.

When the hook mouth 10 is to be opened, as shown in FIG. 3, the operating lever 30 is rotated in the rotational direction as indicated by the arrow shown in FIG. 3 so as to lift the limiting rod 31 from the end section 210 of the guiding groove 21 to an end of the arcuate section 211 and to unblock the latch unit 2, and the latch unit 2 is subsequently rotated in the rotational direction so as to open the hook mouth 110.

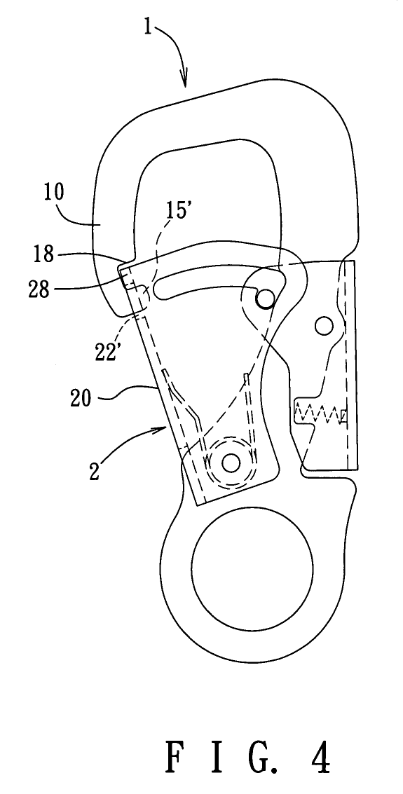

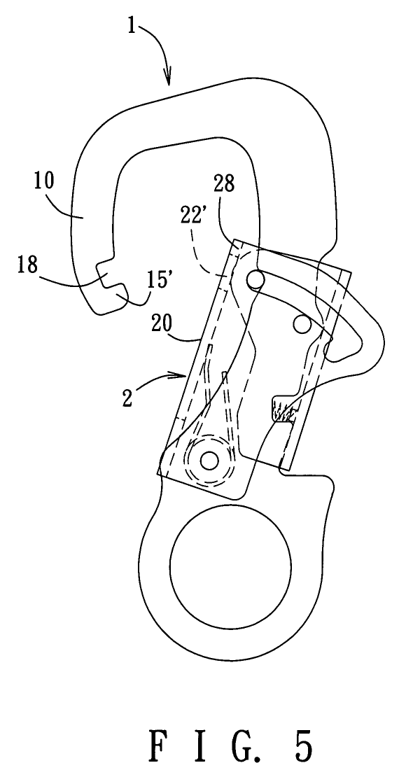

As shown in FIGS. 4 and 5, the second preferred embodiment of the safety hook according to this invention differs from the previous embodiment in that, in addition to the engagement between the protrusion 15′ and the confining hole 22′, the hook segment 10 is further formed with a recess 18 and that the U-shaped plate 20 of the latch unit 2 has a top protrusion 28 which extends into the recess 18 when the latch unit is disposed at the closed position (see FIG. 4). Moreover, the retaining recess 102 formed in the arm segment 12 of the previous embodiment is dispensed with in this preferred embodiment.

By bringing the limiting rod 31 to abut slidingly against the arm segment 12 of the hook body 1 of the safety hook of this invention, the aforesaid drawback associated with the prior art can be alleviated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A safety hook comprising:
a hook body having a base segment, a hook segment cooperating with said base segment to define a hook mouth of said hook body, and an arm segment extending between said base segment and said hook segment;
a latch unit pivoted to said base segment so as to be rotatable relative to said hook body in a rotational direction between closed and opened positions for covering and uncovering said hook mouth, respectively, said latch unit being formed with a guiding groove which has an arcuate section and an end section that turns from said arcuate section and that is defined by an abutting wall; and
a latch-locking unit connected to said latch unit and pivoted to said arm segment so as to be rotatable relative to said hook body between locked and unlocked positions for locking and unlocking said latch unit when said latch unit is disposed at the closed position, said latch-locking unit including an operating lever pivoted to said arm segment, and a limiting rod extending through said operating lever and said guiding groove, co-rotatable with said operating lever, and abutting slidingly against said arm segment, said limiting rod being received in said end section of said guiding groove when said latch-locking unit is disposed at the locked position so as to permit abutment between said limiting rod and said abutting wall, thereby blocking said latch unit from rotating in the rotational direction.

2. The safety hook as claimed in claim 1, wherein said arm segment of said hook body is formed with a retaining recess, said limiting rod being received in said retaining recess when said latch-locking unit is disposed at the locked position.

3. The safety hook as claimed in claim 1, wherein said hook segment has a free end formed with a protrusion, said latch unit including a generally U-shaped plate having a free end that is formed with a confining hole for extension of said protrusion of said free end of said hook segment thereinto when said latch unit is disposed at the closed position.

4. The safety hook as claimed in claim 3, further comprising a torsion spring for urging said U-shaped plate of said latch unit to abut against said free end of said hook segment of said hook body.

5. The safety hook as claimed in claim 3, further comprising a compression spring for urging said operating lever to abut against said arm segment.
